(19) United States
(12) Patent Application Publication
(10) Pub. No.: US 2023/0082925 A1
(43) Pub. Date: Mar. 16, 2023

(54) RECYCLABLE RETORT PACKAGE

(71) Applicant: SESA AMBALAJ VE PLASTIK SANAYI TICARET ANONIM SIRKETI, Izmir (TR)

(72) Inventors: Selim SAVUL, Izmir (TR); Sabi SAVUL, Izmir (TR)

(21) Appl. No.: 17/796,772

(22) PCT Filed: Sep. 24, 2020
(86) PCT No.: PCT/TR2020/050884

§ 371 Date: Aug. 1, 2022

(30) Foreign Application Priority Data
Jan. 31, 2020 (TR) 2020/01497

(51) Int. Cl. B32B 27/08; B32B 27/32; B32B 7/12; B32B 27/30

(52) U.S. Cl. CPC B32B 27/08; B32B 27/32; B32B 7/12; B32B 27/306; B32B 2250/246; B32B 2307/514; B32B 2307/7244; B32B 2307/75; B32B 2439/70

(57) ABSTRACT

The present disclosure relates to a recyclable retort package made of one type (mono) material. Specifically disclosed herein is a recyclable retort package that includes an outer layer and an inner layer, wherein the outer layer includes oriented polypropylene material and the inner layer includes polypropylene material.

### FIELD OF THE INVENTION

The invention relates to a retort package made from a recyclable material.

### BACKGROUND

Retort packages are flexible food packages that can resist heat treatment. Retort packages/pouches, which have a shelf life equivalent to that of metal cans, are seen as the most significant advance in food packaging since the metal cans. These packages are considered as the most suitable alternative to metal cans and glass jars.

These flexible packages that can resist heat treatment have many advantages. The advantages can be listed as below.

Thin wall thickness shortens the heating time and reduces the possibility of overcooking the product while ensuring that the color becomes more appealing, the structure is more durable and the loss of nutritional value is kept to a minimum. Since the pouches are thinner, they transmit the heat to the critical point faster, and thus overcooking of the edges of the product is prevented until the amount of heat required for complete sterilization reaches the critical points during processing. Quality loss of foods due to excessive heat is prevented.

The need for a can opener in the metal cans is no longer present thanks to retort pouches.

The ability to print labels on the laminated products expands the area of use.

Additionally, the retort packages occupy much less space compared to their alternative, the metal cans.

Due to the aforementioned advantages, the retort packages have become highly preferred and widely used packages/pouches today.

The selection of material is critical in the production of retort packages resistant to heat treatment. Long-term preservation of foods should be provided by protecting the package from light-induced deterioration, moisture changes, contact with germs and other interactions.

In the present art, in the ready-to-eat food packaging, retort packages produced by conventional methods are not environmentally friendly and formed by the combination of many different raw materials. Examples of these materials include packages made of materials such as PET/PET ALOX/OPA/PP, PET/ALU/OPA/PP or PETALOX/OPA/PP. Since recycling of these materials would be difficult, recycling of the retort packages made from these materials is not possible, and these disposable packages are not environmentally friendly.

Patent document US2013048636A is an example of the known state of the art. This document relates to a retort package comprising a plurality of layers. It is stated that if the inner pressure exceeds a threshold, these retort packages and multilayer films are self-ventilated by exposure to microwave heating. Being self-ventilated means that the package has different structures and geometries on its different areas. It is seen that a plurality of layers and various materials are used in the packages of this document. However, the document does not mention any use of mono-material and recyclable material.

Another document as an example of the known state of the art is CN106476381A. This document relates to a retort package having resistance to high temperatures. It is stated that the package comprises a polypropylene film layer, a polyamide film layer, a polyimide film layer, a polytetrafluoroethylene film layer, a polyester film layer, a silicone coating and a printing layer, and these layers are attached to each other.

It is seen that the document mentions a retort package consisting of a plurality of layers, each comprising a different material. It is clear that this document does not mention a recyclable retort package, and it will be difficult to recycle due to its having a plurality of different materials.

Accordingly, it is seen that the documents in the known state of the art do not mention a recyclable retort package. The need for improving a retort package made from an environmentally friendly material, a mono-material that is easy to recycle to overcome the disadvantages in the art is still present.

### SUMMARY

The invention relates to a recyclable retort package made of one type (mono) material.

The object of the invention is to produce an environmentally friendly retort package. In accordance with this object, a recyclable material is used as packaging material.

### DETAILED DESCRIPTION

The invention, in general, a retort package comprising an inner layer and an outer layer, wherein the outer layer comprises oriented polypropylene material (OPP) and the inner layer comprises polypropylene (PP) material.

In an embodiment of the invention, the retort package comprises two layers, an outer layer and an inner layer.

In an embodiment of the invention, the outer later comprises OPP (Oriented polypropylene) material. In an embodiment of the invention, the outer layer is printed.

In an embodiment of the invention, the inner later comprises polypropylene (PP) material. In an embodiment of the invention, in addition to the said material, it also comprises EVOH (Ethylene vinyl alcohol) and a plurality of binding materials. These binding materials are materials referred to as tie layer.

In an embodiment of the invention, the inner layer comprises a polypropylene (PP) film produced by a nine layer co-extrusion blowing technique.

The polypropylene (PP) film material contained in the material of the invention is produced by a blowing technique in 5-7 or 9 layer extrusion machines. In this production technique, it is ensured that suitable raw materials are brought together and they resist a predetermined temperature value.

In an embodiment of the invention, in the polypropylene (PP) material comprising EVOH produced by the blowing technique, the materials referred to as tie layer are used as binding materials.

In an embodiment of the invention, the EVOH and the binding materials used can resist a temperature of 130 degrees for 60 minutes.

In an embodiment of the invention, there is a middle layer in addition to the outer layer and the inner layer. In this embodiment, the middle layer comprises an oriented polypropylene material. The purpose of using the middle layer is to enhance oxygen permeability.

In an embodiment of the invention, an adhesive material (glue) is used to attach OPP and PP to each other. In other words, the retort package of the invention comprises an adhesive material (glue) to attach the inner layer and the outer layer or the middle layer and the inner layer to each other.

Briefly, the invention is a recyclable retort package, comprising an outer layer and an inner layer, wherein the outer layer comprises oriented polypropylene (OPP) material and the inner layer comprises polypropylene (PP) material.

Since the package of the invention comprises only one type of raw material, the resulting retort package can be easily used in recycling after use. In this way, used packages are brought back to the industry, and environmental pollution caused by the disposal of packages after use is reduced.

1. A recyclable retort package comprising:
an outer layer and an inner layer; and
wherein the outer layer comprises oriented polypropylene material (OPP) and the inner layer comprises polypropylene (PP) film produced by a five to seven or nine layer co-extrusion blowing technique.

2. The retort package according to claim 1, further comprising a middle layer between the inner layer and the outer layer.

3. The retort package according to claim 2, wherein the middle layer comprises oriented polypropylene material (OPP).

4. The retort package according to claim 3, further comprising an adhesive material to attach the inner layer and the middle layer to each other.

5. (canceled)

6. The retort package according to claim 1, wherein the inner layer comprises ethylene vinyl alcohol (EVOH) and more than one binding material or tie layer that reduces oxygen permeability.

7. The retort package according to claim 1, further comprising an adhesive material to attach the inner layer and the outer layer to each other.

8. The retort package according to claim 1, wherein the outer layer comprises a printing.
